(19) United States
(12) Patent Application Publication
(10) Pub. No.: US 2005/0217452 A1
(43) Pub. Date: Oct. 6, 2005

(54) Saw/grinder attachment

(76) Inventor: Robert L. McDonnell, Twenty Nine Palms, CA (US)

Correspondence Address: DENNISON, SCHULTZ, DOUGHERTY & MACDONALD, 1727 KING STREET, SUITE 105, ALEXANDRIA, VA, 22314, US

(21) Appl. No.: 11/097,193

(22) Filed: Apr. 4, 2005

Related U.S. Application Data
(60) Provisional application No. 60/559,668, filed on Apr. 3, 2004.

(51) Int. Cl. B26D 1/12; B27B 3/00

(52) U.S. Cl. 83/663; 83/666; 83/860

(57) ABSTRACT

A saw attachment is disclosed having an elongated flexible housing with a first end and a second end, a flexible operating shaft disposed within the elongated flexible housing and having a first end and a second end, a power source removably attached to the elongated flexible housing second end, the power source having a shaft operably connected to the flexible operating shaft second end, a gear mechanism having an input end and an output end operably disposed within the elongated flexible housing first end, the flexible operating shaft first end is operably attached to the gear mechanism input end, a circular saw blade operably attached to the gear mechanism output end, wherein, the hacksaw blade remains rotatable by the power source means through the flexible operating shaft and the gear mechanism when the elongated flexible housing is bent at a desired angle.

### CROSS REFERENCE TO RELATED APPLICATIONS

This application claims priority from U.S. Provisional Application Ser. No. 60/559,668, filed Apr. 3, 2004, and titled SAW/GRINDER ATTACHMENT, which is hereby incorporated by reference in its entirety for all purposes.

### FIELD OF THE INVENTION

This invention relates to improvements in handheld electric powered rotary cutting tools, and more particularly to a saw attachment for a cast cutter or an autopsy saw having a flexible extension shaft.

### BACKGROUND OF THE INVENTION

It is presently believed that there may be a commercial demand for a saw/grinder attachment for a power tool in the medical field in accordance with the present invention. There may be a demand since the prior art saw attachments require direct attachment of the saw blade to the power source, or that the attachment is provided by a rigid and inflexible housing limiting the movement of the saw attachment by the operator to access hard to reach places.

It is therefore a primary object of the present invention to provide a saw/grinder attachment that includes a flexible housing.

It is another object of the invention to provide a saw/grinder attachment that is easily operably attached to a conventional power tool such as a Dremel brand tool.

### SUMMARY OF THE INVENTION

These problems and others are addressed by the present invention which comprises a saw attachment is disclosed having an elongated flexible housing with a first end and a second end, a flexible operating shaft disposed within the elongated flexible housing and having a first end and a second end, a power source removably attached to the elongated flexible housing second end, the power source having a shaft operably connected to the flexible operating shaft second end, a gear mechanism having an input end and an output end operably disposed within the elongated flexible housing first end, the flexible operating shaft first end is operably attached to the gear mechanism input end, a circular hack saw blade operably attached to the gear mechanism output end, wherein, the hacksaw blade remains rotatable by the power source means through the flexible operating shaft and the gear mechanism when the elongated flexible housing is bent at a desired angle.

### BRIEF DESCRIPTION OF THE DRAWINGS

These and other objects of the present invention will be appreciated and understood by those skilled in the art from the detailed description of the preferred embodiments of the invention and the following drawings of which:

FIG. 1 is a perspective view of the preferred embodiment of the saw attachment disassembled from a power source;

FIG. 2 is a perspective view of the saw attachment of FIG. 1 in an assembled configuration attached to a power source;

FIG. 3 is a top cross-sectional view of the saw attachment of FIG. 1;

FIG. 3A is a cross-sectional view of the saw attachment for FIG. 3 taken along the line A-A;

FIG. 3B is a cross-sectional view of the saw attachment of FIG. 3 taken along the line B-B; and,

FIG. 4 is a top perspective view of the saw attachment of FIG. 2.

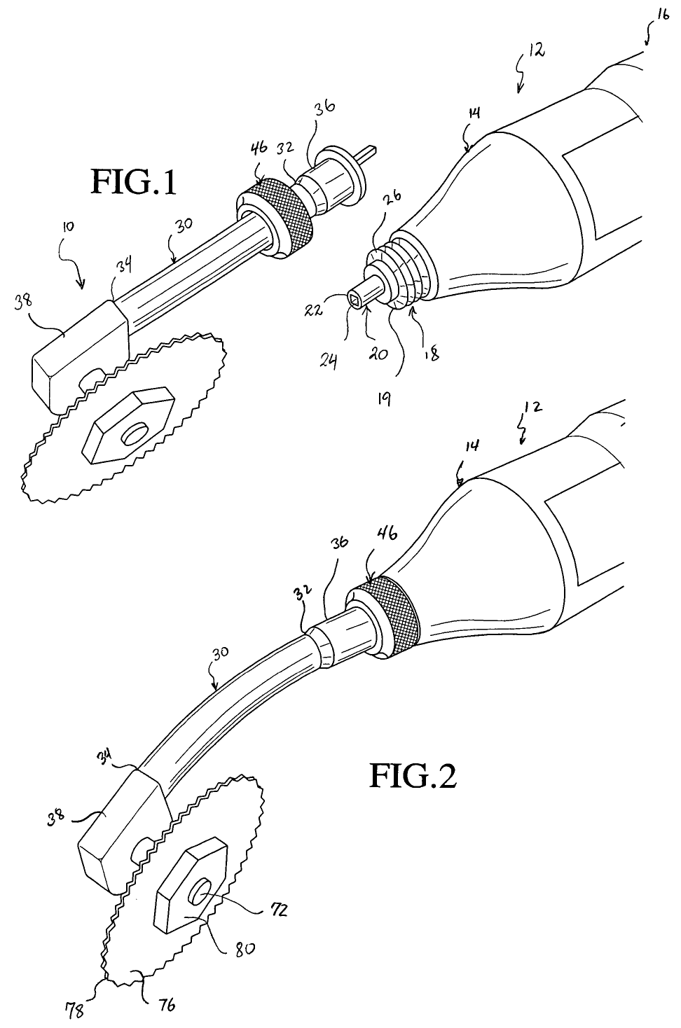

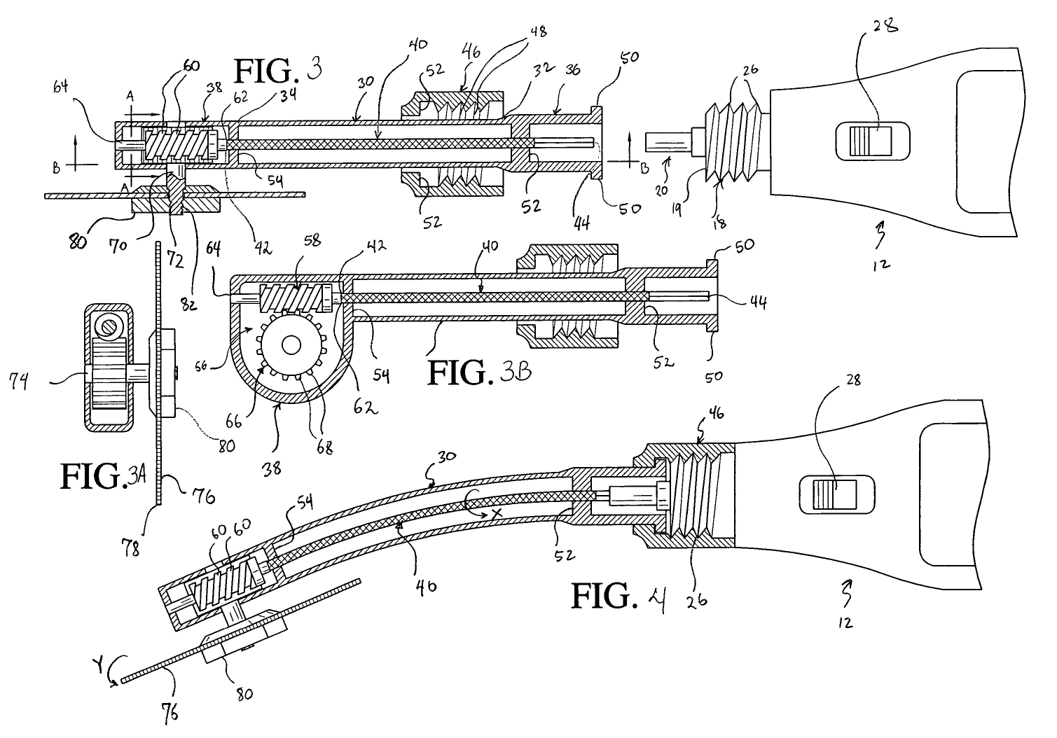

### DETAILED DESCRIPTION OF THE INVENTION

Referring now to the drawings, wherein the showings are for the purpose of illustrating the preferred embodiment of the invention only and not for the purpose of limiting the same, a saw attachment is illustrated at 10. The saw attachment is operable by an electric power source 12 having a variable speed electric motor disposed within a housing 14 preferably made of hard light weight plastic body and having a generally cylindrical shape with a first end 16 and a second end 18. The electric power source may be of Dremel brand or Rotozip brand utility tools, or in the alternative, any other gas power or electric power sources. The second end 18 includes a threaded portion 26 having a plurality of threads on an outer surface thereof. The electric power source 12 also includes an electric switch 28 operably disposed on an outer portion of the housing 14 for operating the variable speed electric motor.

The electric power source 12 comprises a shaft 20 operably attached to the variable speed electric motor at one end, and further includes a second end 22 extending outwardly from the housing second end 18 and operably attachable to the saw attachment 10 as will be explained in greater detail herein. The shaft second end 22 includes a bore 24 having a square-shaped or other type of multi-faceted shaped cross section.

The saw attachment 10 includes an elongated flexible housing 30, preferably, but not limited to, cylindrically shaped, and made from such flexible material that will hold its shape and configuration when bent or deformed, such as, but not limited to, copper or plastic. The elongated flexible housing 30 includes a first end 32 and a second end 34, wherein a first housing portion 36 is attached to, or integral with, the first end 32 and a second housing portion 38 is attached to, or integral with, the elongated flexible housing 30 at the second end 34.

A flexible operating cable or shaft 42, preferably made of, but not limited to, steel or a plurality of steel strands, includes a first end 42 and a second end 44 and is dimensioned and configured to extend within the elongated flexible housing 30, the first housing portion 36, and the second housing portion 38 in a manner which will be discussed. The second end 44 of the flexible operating cable or shaft 42 has a square shape and configuration which will be received within the square-shaped bore 24 of the electric power source shaft 20 to operably rotated the flexible cable or shaft 42. The first portion 36 includes a peripheral flange 50 at one end thereof and is dimensioned and configured to be flush against a front face 19 of the second end 18.

A slidable and threaded sleeve 46 is slidably disposed over the elongated flexible housing 30 and similarly can slide over the first housing portion 36, and includes a plurality of threads 48 therewithin in a lateral direction and is configured to engage with the plurality of threads 26 of the second end 18 of the electric power source 12. The slidable sleeve 46 includes an annular indentation 52 which engages the peripheral flange 50 of the first portion 36, thereby preventing the slidable sleeve 46 to be completely removed from the first housing portion 36 an the elongated flexible housing 30.

The flexible operating cable or shaft 40 is rotatably supported within the elongated flexible housing 30 by extending through a first barrier 52 within the elongated flexible housing 30 and dividing the elongated flexible housing 30 and the first housing portion 36, and a second barrier 54 within the elongated flexible housing 30 dividing the elongated flexible housing 30 and the second housing portion 38.

A gear mechanism 56 is operably supported within the second housing portion 38, and includes a worm gear 58 having a plurality of teeth 60 on an outer surface thereof, and a first end 62 attached to, or integral with, the first end 42 of the flexible operating cable 40, and a second end 64 rotatably supported within an aperture at an end of the second housing portion 38. The gear mechanism 56 further includes a worm wheel 66 having a plurality of teeth 68 on an outer peripheral surface thereof and rotatably disposed within the second housing portion 38 so that the plurality of teeth 68 meshes or engages with the plurality of teeth 60 of the worm gear 58. The worm wheel 66 includes an axial shaft 70 having a first threaded end 72 extending outwardly from the second housing portion 30, and a second end 74 rotatably supported within a back wall of the second housing portion 38.

A circular hacksaw blade 76, or other types of cutting blades such as, but not limited to, a Carborundum blade, includes a plurality of cutting teeth 78 disposed along a peripheral edge thereof, and includes a central bore for receiving the first threaded end 72 of the axial shaft 70 therethrough. A nut 80 having a threaded bore 82 removably secures the circular hacksaw blade 76 to the axial shaft 70 by tightening the nut 80 as the first threaded end 72 of the axial shaft 70 engaged with the threaded bore 82 of the nut 80.

The rotational movement of the flexible operating cable or shaft 40 in the direction of X will result in the rotational movement of circular hacksaw blade 76 in the Y direction through the gear mechanism 56 wherein the shaft 20 rotates the flexible operating cable or shaft 40, which will in turn rotate the worm gear 58, which will in turn rotate the worm wheel 66, resulting in the rotation of the circular hacksaw blade 76.

As best seen in FIGS. 2 and 4, the saw attachment 10 is operably connected to the electric power source 12, and the elongated flexible housing 30 is bent to provide better cutting access in hard to reach places.

While preferred embodiments of the invention have been shown and described, various modifications and substitutions may be made thereto without departing from the spirit and scope of the invention. Accordingly, it is to be understood that the present invention has been described by way of illustration only, and this description should not be construed as limiting to the several claims appended hereto.

1. A saw attachment, comprising:
an elongated flexible housing having a first end and a second end;
a flexible operating shaft disposed within said elongated flexible housing and having a first end and a second end;
a power source means removably attached to said elongated flexible housing second end, said power source means having a shaft operably connected to said flexible operating shaft second end;
a gear mechanism having an input end and an output end operably disposed within said elongated flexible housing first end;
said flexible operating shaft first end is operably attached to said gear mechanism input end;
a circular hack saw blade operably attached to said gear mechanism output end; wherein,
said circular hacksaw blade remains rotatable by said power source means through said flexible operating shaft and said gear mechanism when said elongated flexible housing is bent at a desired angle.

2. The saw attachment of claim 1, wherein said elongated flexible housing is made from copper.

3. The saw attachment of claim 1, wherein said gear mechanism includes a worm gear and a worm wheel meshed with said worm gear.

4. The saw attachment of claim 1, wherein said power source means is an electric motor having a variable speed electric motor.

5. The saw attachment of claim 4, wherein said electric motor includes a housing having a first threaded end, said shaft extending outwardly from said first threaded end, said elongated flexible housing having slidable sleeve with an inner threaded portion engageable with said first threaded end when said elongated flexible housing is attached to said electric motor.

6. The saw attachment of claim 3, wherein said worm gear includes a first end attached to said flexible operating cable at one end, and rotatably supported within elongated flexible housing second end.

7. The saw attachment of claim 3, wherein said worm wheel includes an axial shaft having a first threaded end extending outwardly from said elongated flexible housing and engageable with a nut for removably securing said hacksaw blade.

8. The saw attachment of claim 1, wherein said power source means is gas powered motor.
